(19) United States
(12) Patent Application Publication
(10) Pub. No.: US 2026/0111492 A1
(43) Pub. Date: Apr. 23, 2026

(54) Dynamic Query Classification and Routing in Multi-Model AI Architectures

(71) Applicant: Open Text Technologies, India Private Limited, Hyderabad (IN)

(72) Inventors: Sangeetha Yanamandra, Hyderabad (IN); Aditya Banda, Hyderabad (IN); Thirumalesh Yenagandula, Hyderabad (IN); Ravinderreddy Yeddla, Hyderabad (IN); Pradeep Neerukonda, Anakapalli (IN)

(21) Appl. No.: 18/924,891

(22) Filed: Oct. 23, 2024

Related U.S. Application Data
(63) Continuation of application No. 18/922,210, filed on Oct. 21, 2024.

(51) Int. Cl. G06F 16/903; G06N 20/10

(52) U.S. Cl. CPC G06F 16/90335; G06N 20/10

(57) ABSTRACT

The present disclosure pertains to dynamic query classification and routing in multi-model AI (Artificial Intelligence) architectures. A method includes receiving a user query at a computing device, generating an embedding representation of the query using a pre-trained language model, and applying a trained classifier to the embedding representation to determine the query's type. The classifier categorizes the query into one of three types: information retrieval, document retrieval, or document summary. A response is then generated based on the classified query type, enhancing the system's ability to provide relevant and accurate results to users.

### CROSS-REFERENCE TO RELATED APPLICATIONS

This application is a continuation application of U.S. patent application Ser. No. 18/922,210, filed Oct. 21, 2014, entitled “Configurable Large Language Model Integration and Management Across Cloud and On-Premises Environments,” the disclosure of which is hereby incorporated by reference in its entirety.

### FIELD

The present disclosure is directed to the classification of user queries in a content retrieval system. The present disclosure focuses on utilizing a trained classifier to categorize user queries into different types, such as information retrieval, document retrieval, or document summarization, to enable the system to provide more relevant and accurate responses.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method for classifying a user query in a content retrieval system. The computer-implemented method also includes receiving, at a computing device, a user query; generating an embedding representation of the user query using a pre-trained language model; applying a trained classifier to the embedding representation to create a classified question type for the user query, where the trained classifier is configured to classify the user query into one of at least three question types: an information retrieval question type, a document retrieval question type, and a document summary question type; and generating a response to the user query based on a classified question type. Other embodiments of this aspect include corresponding computer systems, apparatus, and computer programs recorded on one or more computer storage devices, each configured to perform the actions of the methods.

Implementations may include one or more of the following features. The method where the trained classifier is a support vector machine (SVM) classifier. Training the trained classifier may include: providing a plurality of labeled training queries, each labeled training query having a corresponding question type; generating embedding representations for the plurality of labeled training queries using the pre-trained language model; and training the trained classifier on the plurality of labeled training queries and their corresponding embedding representations. Generating the response further may include: if the classified question type is an information retrieval question type, retrieving information related to the user query from a vector database; synthesizing an answer to the user query based on the retrieved information; and providing the synthesized answer to a user. Generating the response further may include: if the classified question type is a document retrieval question type, retrieving a document related to the user query from a vector database; and providing the retrieved document to a user. Generating the response further may include: if the classified question type is a document summary question type, retrieving a document related to the user query from a vector database; generating a summary of the retrieved document; and providing the summary to a user. The method may include training a support vector machine (SVM) classifier by: receiving a plurality of labeled training queries, each labeled training query associated with a specific query type; generating embedding representations for the labeled training queries using a pre-trained language model; and applying the SVM classifier to the embedding representations to learn classification boundaries for distinguishing between query types. The specific query type includes at least an information retrieval query type, a document retrieval query type, and a document summary query type, the embedding representations are generated using a transformer-based language model. The method may include evaluating performance of the trained SVM classifier using a test set of labeled queries and adjusting classifier parameters based on evaluation results. The trained SVM classifier is configured to output a probability score for each potential query type, and a query type with a highest probability score is selected as a predicted classification. Implementations of the described techniques may include hardware, a method or process, or computer software on a computer-accessible medium.

One general aspect includes a computer system for classifying a user query in a content retrieval system a processor and memory for storing instructions, the processor executing the instructions to: receive a user query; generate an embedding representation of the user query using a pre-trained language model; receive the embedding representation; classify the user query into one of at least three question types, including an information retrieval question type, a document retrieval question type, and a document summary question type; generate a response to the user query based on a classified question type, where the response includes one of retrieving information related to the user query from a vector database and synthesizing an answer based on the retrieved information, retrieving a document related to the user query from the vector database, or generating a summary of a retrieved document from the vector database. Other embodiments of this aspect include corresponding computer systems, apparatus, and computer programs recorded on one or more computer storage devices, each configured to perform the actions of the methods.

Implementations may include one or more of the following features. The system where the processor is configured to generate embedding representations for the user query using a pre-trained language model. The processor is configured to train the SVM by: receiving a plurality of labeled training queries, each labeled training query associated with a specific query type; generating embedding representations for the labeled training queries using a pre-trained language model; and applying the SVM classifier to the embedding representations to learn classification boundaries for distinguishing between query types. The query types include at least an information retrieval query type, a document retrieval query type, and a document summary query type. The embedding representations are generated using a transformer-based language model. The processor is configured to evaluate performance of the trained svm classifier using a test set of labeled queries and adjusting classifier parameters based on the evaluation results, where the trained SVM classifier is configured to output a probability score for each potential query type, and the query type with a highest probability score is selected as a predicted classification. Implementations of the described techniques may include hardware, a method or process, or computer software on a computer-accessible medium.

One general aspect includes a system for processing user queries in a content retrieval system. The system also includes a query interface configured to receive a user query and transmit the user query to a query classifier module; a query classifier module configured to: generate an embedding representation of the user query using a pre-trained language model; and apply a trained classifier to the embedding representation to predict a query type for the user query, where the query type is classified into one of at least three query types: an information retrieval query type, a document retrieval query type, and a document summary query type. The system also includes a context builder module configured to: receive a classified query type from the query classifier module, and generate a context for the user query based on the classified query type. The system also includes a retriever module configured to: access and retrieve relevant information or documents from a vector database based on the context generated by the context builder module. The system also includes a large language model (LLM) processor configured to: receive the retrieved information or document and generate a corresponding output based on the context, and forward output to the query interface for presentation to a user. Other embodiments of this aspect include corresponding computer systems, apparatus, and computer programs recorded on one or more computer storage devices, each configured to perform the actions of the methods.

Implementations may include one or more of the following features. The system where the trained classifier is a support vector machine (SVM) classifier. The SVM classifier is trained by: providing a plurality of labeled training queries, each labeled training query having a corresponding question type; generating embedding representations for the plurality of labeled training queries using a pre-trained language model; and training the classifier on the plurality of labeled training queries and their corresponding embedding representations. Implementations of the described techniques may include hardware, a method or process, or computer software on a computer-accessible medium.

### BRIEF DESCRIPTION OF THE DRAWINGS

FIG. 1 illustrates a system architecture designed to facilitate the integration of multiple Large Language Models (LLMs) based on configurable user preferences.

FIG. 2 depicts an advanced architecture within the aviator stack of the aviator search of FIG. 1, designed to manage and deploy multiple large language models and other machine learning models.

FIG. 3 illustrates the detailed process for registering and deploying machine learning models within the aviator stack, focusing on both cloud-based and locally hosted models.

FIG. 4 illustrates the process of Model Test Inference for cloud-based large language models (LLMs) within the aviator stack.

FIG. 5 illustrates the process of model test inference for hosted large language models (LLMs) within the aviator stack.

FIG. 6 illustrates the query classification process within the Aviator stack, detailing how user questions are categorized and routed to the appropriate services.

FIG. 7 illustrates the process of training and applying a classification model, such as a Support Vector Machine (SVM), to categorize user queries into specific types, such as information retrieval, document retrieval, or document summary

FIG. 8 illustrates the information retrieval flow within the Aviator stack, showcasing how a user's question is processed through various components to generate an appropriate response.

FIG. 9 illustrates a document retrieval flow showing the process by which a user interacts with the aviator stack to retrieve relevant documents.

FIG. 10 illustrates the document summary flow within the aviator stack, detailing the sequential steps that take place when a user submits a query for document summarization.

FIG. 11 is a diagrammatic representation of an example machine in the form of a computer system.

### DETAILED DESCRIPTION OF EXAMPLE EMBODIMENTS

### Overview

The present disclosure pertains to integrating and managing configurable Large Language Models (LLMs) across various computing environments, including cloud-based platforms, on-premises systems, and hybrid deployments. One implementation addresses the growing demand for flexibility in selecting and deploying LLMs, such as OpenAI™, Amazon Bedrock™, and Vertex AI™, based on organizational preferences and infrastructure.

In addition to supporting multiple LLMs and model types, the system introduces a novel approach to intelligently select and route queries to the most appropriate LLM based on query classification. This dynamic selection process ensures that the system leverages the unique strengths of each LLM, optimizing performance and accuracy for various tasks. Furthermore, the system enables seamless integration of cloud-based and on-premises models, providing organizations with the flexibility to deploy LLMs in the environment that best suits their needs, whether it is for cost efficiency, data privacy, or specific use case requirements.

A significant challenge in modern AI deployment is that organizations often have specific preferences for certain LLMs due to existing cloud service commitments or specific use cases that require on-premises solutions. This disclosure provides a solution by offering a flexible configuration framework that supports the integration of multiple LLMs, whether hosted on the cloud or within an organization's local infrastructure. This flexibility is important for enterprises that need to leverage different LLMs based on various factors such as cost, performance, and data privacy requirements.

One implementation includes the ability to provide configuration options during deployment, allowing users to select and integrate one or more LLMs from a variety of sources, including hosted LLMs, Vertex AI, OpenAI, and Amazon Bedrock. This selection process is streamlined through a user-friendly interface that guides customers in configuring their chosen LLMs according to their specific needs. Additionally, the system supports the integration of other neural network models alongside LLMs, enhancing the system's ability to handle diverse AI workloads.

To further augment its capabilities, a disclosed system incorporates a question classification model that works in tandem with LLMs to optimize information retrieval and document processing. This classifier intelligently distinguishes between different types of queries—such as information retrieval, document retrieval, and document summarization—and routes them through the appropriate processing pathways. For example, in a use case involving document retrieval, the classifier might utilize an LLM for generating summaries or detailed responses while simultaneously employing a different neural network model to handle specific retrieval tasks.

Some implementations include an LLM processor layer that acts as an intermediary between the prompt builder/UI and the selected LLMs. This processor layer is preconfigured to determine which LLM scenario to apply based on the user's deployment choices and query types, ensuring that the system consistently uses the most suitable model for the task at hand. This modular approach allows organizations to deploy and manage multiple LLMs seamlessly, whether on-premises, in the cloud, or across hybrid environments.

The LLM prompt builder service is another component of the system, designed to facilitate the creation and customization of prompts used by LLMs. It provides a repository of pre-existing templates and allows users to save custom templates, enhancing the efficiency and consistency of LLM interactions. This service integrates functionally with the LLM processor layer to ensure that the correct prompts are delivered to the appropriate LLMs, based on the query classification.

Additionally, the system supports model inference across both cloud-based and on-premises LLMs, utilizing the KServe™ platform to deploy and manage models in the Open Neural Network Exchange (ONNX) format. This ensures compatibility across different computing environments and allows for efficient resource allocation, whether the models are running on CPUs, GPUs, or TPUs.

An orchestrator service manages the deployment and maintenance of LLMs and other models, including tasks such as starting, stopping, and monitoring the health of deployed models. This service ensures that models are readily available and can be scaled up or down based on demand, contributing to the overall efficiency and resilience of the system.

One example system allows for integrating, managing, and testing LLMs across cloud, on-premises, and hybrid environments. The system allows organizations to flexibly configure, deploy, and test multiple LLMs, such as OpenAI, Amazon Bedrock, and Vertex AI, alongside other neural network models. Key features include a model administration module for managing execution parameters, an orchestrator service for deploying and maintaining models, a conversion service for standardizing models into a common format, and a testing framework for evaluating model performance. The system supports advanced query classification, directs queries to the appropriate models, and ensures seamless LLM operations across diverse platforms.

In sum, the disclosed technology represents a significant advancement in the field of AI model integration and management. By offering a flexible, configurable, and secure system that supports the deployment of multiple LLMs and neural network models across various environments, the system disclosed herein provides organizations with the tools they need to fully leverage the capabilities of modern AI, tailored to their unique operational requirements.

### EXAMPLE EMBODIMENTS

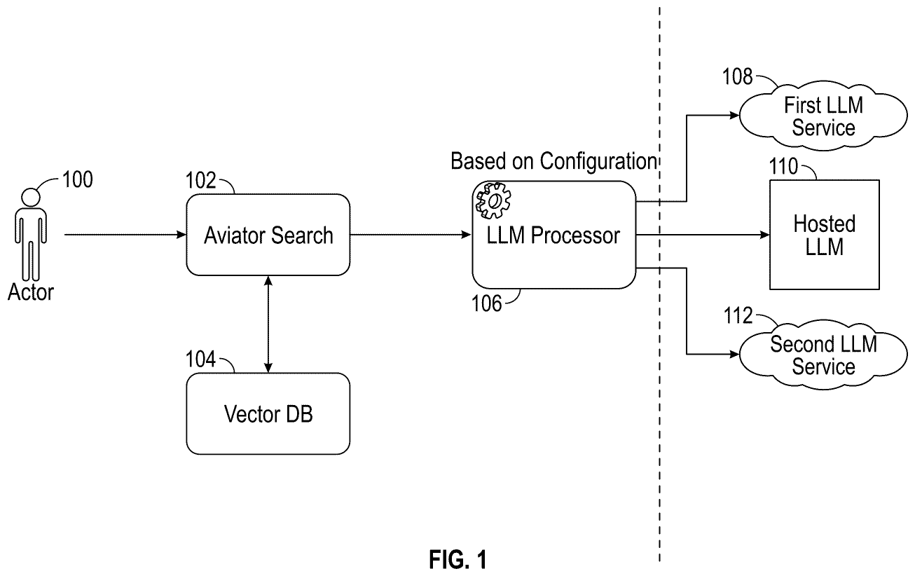

FIG. 1 illustrates a system architecture designed to facilitate the integration of multiple LLMs based on configurable user preferences. An actor 100 (also referred to as a user or querier) initiates a query using aviator search 102, which serves as the primary interface for user interactions. The aviator search 102 interacts with a vector DB 104, a database optimized for handling vector-based data storage and retrieval, enabling efficient data management and query processing.

Received queries are then passed to the LLM processor 106, which is responsible for routing the query to the appropriate LLM based on the configuration specified by the user. Depending on this configuration, the LLM processor 106 may direct the query to one of several LLM services, such as first LLM service AI 108, an example cloud-based LLM option, or a hosted LLM 110, which refers to an LLM that is locally hosted within the user's infrastructure.

Additionally, the system supports integration with a second LLM service 112, an example cloud-based LLM service, providing further flexibility in how LLMs are deployed and managed within the system. This architecture demonstrates the system's ability to adapt to various operational needs by supporting multiple LLMs across different environments, offering a customizable and scalable solution for organizations looking to leverage advanced AI capabilities.

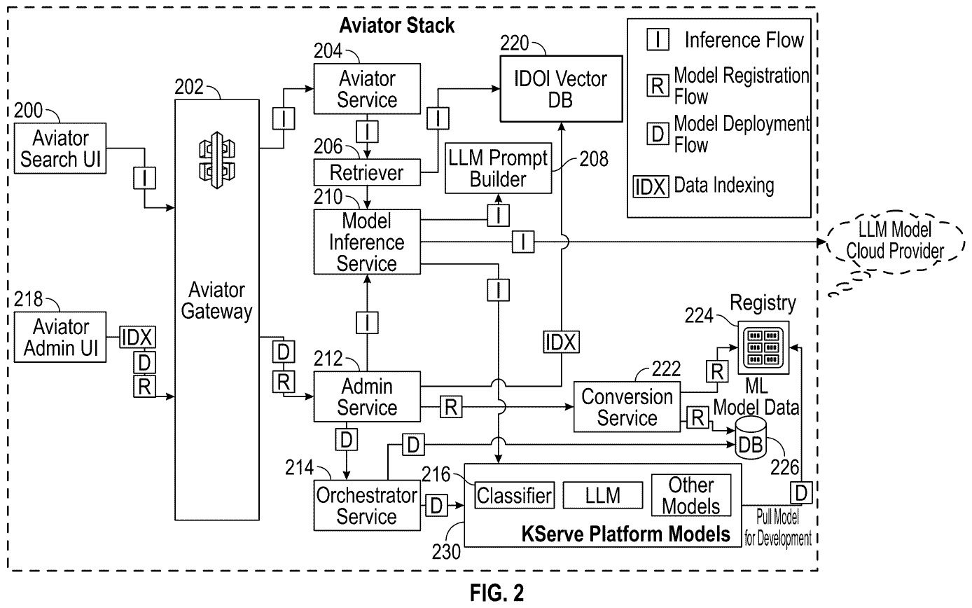

FIG. 2 depicts an architecture, referred to as an aviator stack, of the aviator search 102 of FIG. 1. This architecture is designed to manage and deploy multiple large language models and other machine learning models. This architecture includes the aviator query UI 200, where users enter their queries.

The aviator query UI 200 serves as an interface through which users engage with the aviator stack, allowing them to input queries and interact with the system's search capabilities. The aviator query UI 200 is designed to handle a wide range of search requests, from simple keyword searches to more complex natural language queries that require advanced processing by the integrated large language models and other machine learning models.

Once a query is submitted, the aviator query UI 200 is responsible for displaying the results generated by the system. These results are processed by the various models within the aviator stack and presented in a clear and accessible manner, allowing users to easily navigate through the information. The interface may include options to sort, filter, or categorize the results based on factors like relevance or date, further improving usability.

The aviator query UI 200 is coupled with the aviator gateway 202 to route queries to the appropriate services for processing. The aviator query UI 200 couples with the model inference service 210 to ensure that queries are analyzed by the correct models and that the results are returned promptly. This integration ensures that the entire search process, from query input to result display, is efficient and effective.

One of the functions of the aviator gateway 202 is to efficiently manage and balance the workload across the system. As queries enter the aviator gateway 202, it determines the best path for processing based on the nature of the query and the current system load. This includes routing queries to the aviator service 204 for processing and directing them to the model inference service 210 for more complex tasks involving large language models or other machine learning models.

In addition to routing queries, the aviator gateway 202 handles various aspects of data flow and communication between components. It ensures that the necessary data is passed between the query UI 200, the inference models, and the other services within the stack. This orchestration by the aviator gateway 202 is used to maintain system performance and ensure that queries are processed quickly and accurately.

The aviator gateway 202 also plays a role in security and access control. It can enforce authentication and authorization policies, ensuring that only authorized users and services can access certain parts of the system. This is particularly important in environments where sensitive data is being processed or where compliance with specific regulations is required.

The aviator service 204 is a component within the aviator stack, responsible for the primary processing of user queries. Upon receiving a query routed by the aviator gateway 202, the aviator service 204 initiates the necessary operations to fulfill the request.

The aviator service 204 is communicatively coupled with the retriever 206, which is tasked with accessing and retrieving relevant data in response to the query. This retrieved data is then processed by the aviator service 204, which may involve further coordination with the model inference service 210 for queries requiring advanced computational analysis, such as those involving large language models or other machine learning models.

In its role, the aviator service 204 manages the flow of information between the query UI 200 and other downstream components, ensuring that data is processed efficiently and transmitted to the appropriate modules for further action. The service is also responsible for enforcing system protocols and ensuring that each query is handled according to predefined security and operational guidelines. By managing these tasks, the aviator service 204 ensures that the aviator stack operates effectively, processing user queries with accuracy and efficiency while maintaining the integrity and security of the system.

The retriever 206 operates by executing search operations based on the parameters defined by the aviator service 204. These parameters are derived from the initial query inputted through the query UI 200 and processed by the aviator service 204. The retriever 206 utilizes these parameters to perform targeted searches, ensuring that only the most relevant data is extracted and passed back to the aviator service 204 for further processing.

Once the data is retrieved, the LLM prompt builder 208 constructs and manages prompts tailored for various large language models. Upon receiving a user query, the context builder interacts with the classifier to determine the query type-whether it's an information retrieval, document retrieval, or document summarization request. Based on this classification, the context builder intelligently routes the query to the appropriate service. For information retrieval queries, the context builder interacts with IDOL (Intelligent Data Operating Layer) vector database 220 to retrieve relevant information and then passes this information to the LLM processor for generating a synthesized response. In the case of document retrieval queries, the context builder directly interacts with IDOL vector database 220 to fetch the relevant document and return it to the user. For document summarization queries, the context builder retrieves the document content from IDOL vector database 220 and sends it to the LLM processor to generate a concise summary. The context builder's ability to dynamically manage these interactions based on query classification ensures that each query is processed efficiently and accurately, delivering the most relevant and useful response to the user.

One function of the LLM prompt builder 208 is to ensure that the data sent to the LLMs is both syntactically and semantically suitable for processing. This can involve reformatting the query text, selecting appropriate language and structure, and potentially augmenting the prompt with additional context or metadata to enhance the accuracy and relevance of the model's output.

Additionally, the LLM prompt builder 208 may include logic for adapting prompts to the specific capabilities and limitations of different LLMs. This ensures that the prompts are optimized for the particular model in use, whether it involves handling natural language queries, generating responses, or performing complex text-based tasks. LLM prompt builder 208 can construct prompts from pre-existing templates and save custom prompt templates created by customers.

By accurately constructing these prompts, the LLM prompt builder 208 facilitates effective communication between the aviator stack and the integrated LLMs, enabling the system to generate precise and contextually relevant responses to user queries. This component plays an essential role in bridging the gap between user inputs and the sophisticated processing capabilities of LLMs, ensuring that the models perform effectively within the broader system architecture.

These prompts are then processed by the model inference service 210, which uses the LLMs or other machine learning models to generate the necessary responses. The model inference service 210 is a component within the aviator stack responsible for executing the computational tasks required to generate outputs from LLMs and other machine learning models. After receiving a formatted prompt from the LLM prompt builder 208, the model inference service 210 processes the input by applying the appropriate models to produce the desired results. The model inference service 210 handles inference calls, interacts with the LLM prompt builder 208 and forwards requests to the appropriate LLM model (whether cloud-based or hosted).

The model inference service 210 is designed to handle various types of inference tasks, including natural language processing, text generation, and data analysis. It is equipped to work with different types of models, allowing it to accommodate a wide range of query types and computational needs. This service ensures that the models are correctly applied based on the input parameters, delivering accurate and relevant outputs.

The model inference service 210 also manages the execution environment for the models, ensuring that the necessary computational resources, such as CPU or GPU, are allocated efficiently. It communicates with other components, such as the aviator service 204, to receive the prompts and transmit the processed results back to the appropriate destination, typically for presentation to the user through the query UI 200.

Administrative control of the system is handled through the aviator admin UI 218, which works in conjunction with the admin service 212. The admin service 212 oversees model registration and orchestration, ensuring that all models are correctly managed within the system. The orchestrator service 214 is responsible for deploying, managing, and maintaining these models across the platform. This service is responsible for deploying a model into the local environment and managing model maintenance actions, including starting, stopping, deleting, deploying, and performing health checks.

Additionally, the classifier 216 determines the type of query being processed, ensuring that each query follows the appropriate path through the system. Additional details on the classifier 216 are provided in greater detail infra.

The architecture also integrates with IDOL vector database 220, which enhance the system's processing capabilities. The IDOL vector database 220 includes elements within the aviator stack, designed to enhance the system's ability to process, analyze, and retrieve information from vast datasets. The IDOL vector database 220 are responsible for performing advanced data operations that complement the capabilities of the LLMs and other machine learning models integrated into the system.

One function of the IDOL vector database 220 is to facilitate data indexing, search, and retrieval processes. These components use algorithms to analyze unstructured data, enabling the system to extract meaningful insights and deliver relevant information quickly. By indexing data effectively, the IDOL vector database 220 ensure that searches conducted through the query UI 200 are efficient and yield precise results.

Additionally, the IDOL vector database 220 may provide capabilities for natural language processing, sentiment analysis, entity recognition, and other text analytics tasks. These functions allow the aviator stack to go beyond simple keyword matching, offering context-aware responses to user queries.

The IDOL vector database 220 is also involved in the integration of diverse data sources, enabling the aviator stack to handle data from various repositories, including structured databases and unstructured document collections. This versatility ensures that the system can operate effectively in environments with heterogeneous data types and sources.

The conversion service 222 is a component within the aviator stack, responsible for transforming various machine learning models into a standardized format, ensuring compatibility across different deployment environments. The conversion service 222 handles a diverse set of models, such as large language models and other neural network models, that may have been originally developed using different frameworks or architectures. By converting these models into a common format, typically the ONNX format, the conversion service 222 enables seamless integration and deployment within the system. This standardized format ensures that models can be consistently managed, executed, and scaled across various cloud-based and on-premises platforms, thereby enhancing the overall flexibility and interoperability of the aviator stack. Additionally, the conversion process also involves the preservation of key model metadata, including input/output specifications and resource allocation requirements, which are essential for accurate and efficient model deployment.

The registry 224 manages the storage and organization of models that are deployed and utilized within the system. Specifically, the registry 224 functions as a centralized repository where various models, including large language models and other machine learning models, are stored after being processed into a standardized format.

Once a model has been processed and standardized, it is registered within the registry 224. This registration process includes storing essential metadata about the model, such as the model name, the parameters used, input and output formats, and the specific path within the registry where the model is stored. This metadata is used for managing the models throughout their lifecycle, from initial deployment to potential updates or redeployments.

The registry 224 also facilitates the management of model versions, allowing administrators to keep track of different versions of a model and ensuring that the correct version is deployed based on the operational requirements. Additionally, the registry 224 interacts with other components, such as the deployment services, to retrieve the necessary model information when a model needs to be deployed or updated in the system.

The ML model database 226 stores machine learning model data, used for smooth retrieval and deployment processes across the system. Specifically, this database holds an array of model-related information, including model metadata, configuration parameters, and health status. The ML model database 226 serves as a central repository that ensures all models-whether they are large language models (LLMs) or smaller machine learning models-are readily accessible for deployment and inference operations.

Moreover, the ML model database 226 works in tandem with the registry 224, where the models are stored after being converted into a common format, such as ONNX. The ML model database 226 keeps track of the model's status—whether it is currently deployed, running, or idle—allowing administrators to manage and monitor the models effectively. This comprehensive storage and management capability provided by the ML model database 226 ensures that the aviator stack can handle complex AI workloads with high reliability and scalability.

FIG. 2 also outlines several distinct flow types within the aviator stack, each representing an aspect of the system's operation. These flow types include the inference flow, which handles the processing and response generation for user queries; the model registration flow, which manages the registration and configuration of models within the system; the model deployment flow, which oversees the deployment and operational management of these models; and the data indexing flow, which organizes and optimizes data for efficient retrieval. Together, these flow types illustrate the comprehensive and interconnected processes that enable the aviator stack to function effectively, supporting advanced AI workloads and ensuring robust system performance.

The inference flow in FIG. 2 begins when a user inputs a query through the aviator query UI 200. This query is sent to the aviator gateway 202, which routes the request to the aviator service 204. The aviator service processes the query and collaborates with the retriever 206 to identify and fetch relevant data. Once the necessary data is retrieved, it is passed along to the model inference service 210.

Within the model inference service 210, the query is analyzed and processed using various large language models or other machine learning models. To prepare the query for processing, the LLM prompt builder 208 constructs prompts tailored to the specific requirements of the selected model. The processed output from the LLM or model is then generated as a response to the initial query.

Throughout this flow, the system ensures that the appropriate model is used by leveraging the classifier 216, which determines the type of query and directs it accordingly. The inference flow concludes as the processed response is delivered back to the user, providing accurate and relevant results based on the input query.

The model deployment flow in FIG. 2 begins with the admin service 212, which initiates the deployment process by coordinating with the orchestrator service 214. The orchestrator service 214 is responsible for managing the lifecycle of the models, including tasks such as starting, stopping, and monitoring model performance. Once a model is selected for deployment, the orchestrator service 214 interacts with the conversion service 222 to ensure that the model is in the correct format for deployment.

After conversion, the orchestrator service retrieves the model from the registry 224, which houses all registered models and their configurations. A model is then pulled from the ML model database 226, where the actual machine learning model data is stored, and deployed onto the KServe platform 230 within the Kubernetes environment. This platform hosts the models, making them available for inference tasks.

The KServe platform 230 is responsible for hosting various models, including classifiers, LLMs, and other machine learning models, within a Kubernetes environment. This platform provides services such as auto-scaling, logging, monitoring, and model serving, which are integral for maintaining the operational efficiency and scalability of the aviator stack. The KServe platform 230 ensures that models are not only deployed effectively but also continuously managed and monitored, allowing for dynamic adjustments based on real-time operational needs and resource availability. The integration of the KServe platform 230 with the orchestrator service 214 ensures seamless deployment and maintenance of models, supporting the overall flexibility and scalability of the system.

Throughout the deployment flow, the orchestrator service ensures that the models are correctly deployed and maintained, ready to be utilized by the system for processing user queries and other tasks. This flow enables the aviator stack to dynamically deploy and manage multiple models, ensuring that the system remains flexible and scalable.

The IDX flow in FIG. 2 pertains to the indexing of data within the aviator stack, ensuring that data is organized and optimized for efficient retrieval and processing. This flow begins at the aviator admin UI 218, where data indexing tasks are initiated. The admin service 212 oversees this process, managing how data is indexed and stored within the system.

The indexed data is then passed to the conversion service 222, which processes and prepares the data for use in various models and components. The conversion service ensures that the data is compatible with the system's format requirements, making it ready for deployment and inference tasks. This indexed data ensures efficient model operation, particularly in large-scale environments where quick data access and retrieval are necessary for performance. Finally, the conversion service interacts with the model inference service 210 and other system components to ensure that the indexed data is readily available for queries and processing tasks.

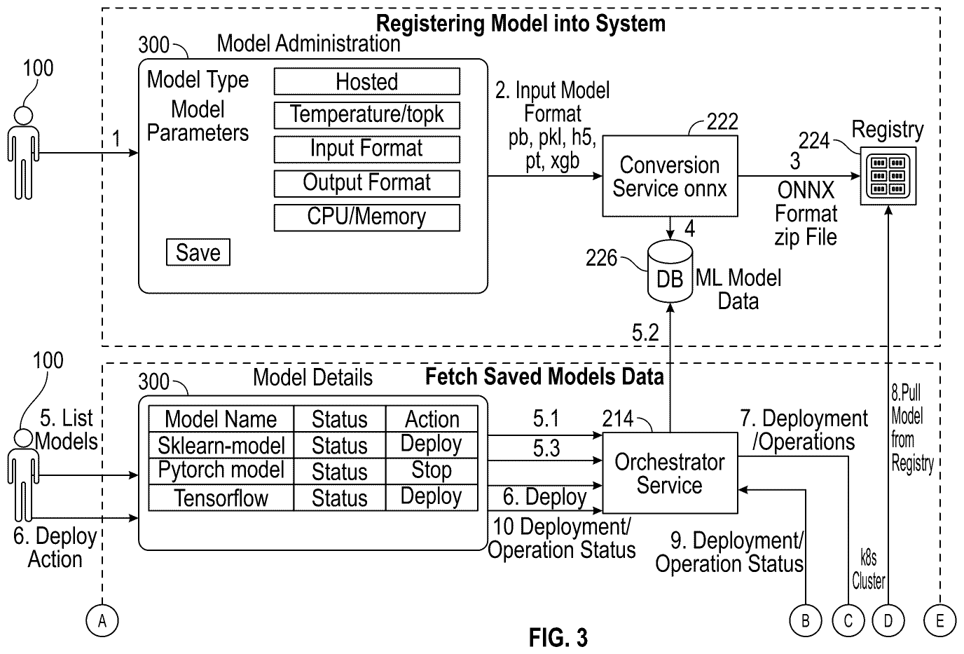

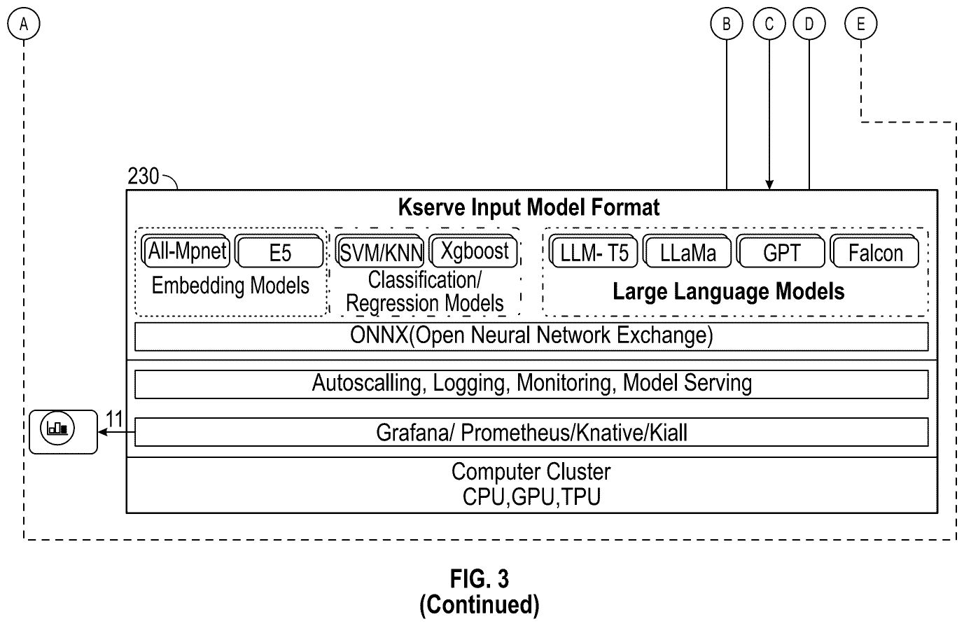

FIG. 3 illustrates the detailed process for registering and deploying machine learning models within the aviator stack, focusing on both cloud-based and locally hosted models. The process starts with the actor 100 (see FIG. 1), who uses the aviator search UI to access the model administration interface 300. Here, the actor configures the model's parameters, such as selecting the model type—be it a LLM, artificial neural network (ANN), or smaller models like support vector machines (SVM) or k-nearest neighbors (KNN). For LLMs, additional parameters like temperature, top-k sampling, top-p sampling, maximum output tokens, beam width, and prompt length are adjusted to refine the model's behavior during inference.

The temperature parameter controls the randomness of the output, where lower values such as 0.0 make the model more deterministic, while higher values up to 2.0 introduce more randomness. Top-k sampling limits the model's choices to the top-k most likely tokens, with a range from 1 to 1000. Top-p sampling, also known as nucleus sampling, selects tokens from a subset where the cumulative probability exceeds a threshold p, with a range from 0.0 to 1.0. The maximum output tokens parameter defines the maximum length of the generated text, with a range extending from 1 to 2048 or more tokens. Beam width determines the number of candidate sequences considered during beam search, typically ranging from 1 to 10 or more. Finally, prompt length specifies the portion of the input text considered during processing, with a range that can extend from 10 to 4096 tokens or more, depending on the model's context window.

Parameters for other model types, such as ANN, SVM, or KNN, include the input format, which dictates the structure of the inference call—whether in JSON, text, CSV, image, or other formats—and the output format, which specifies the expected output format.

Once the actor finalizes the configuration, the data is sent to the conversion service 222. The conversion service 222 transforms the model into the ONNX format, ensuring compatibility across various platforms within the aviator stack. This conversion process maintains consistency across different deployment environments. After the conversion, the model and its metadata—such as input/output formats and resource allocation requirements—are stored in the ML model database 226.

The model parameters are then registered in the registry 224, which is the central repository for model parameter storage within the system. In more detail, the registry 224 is responsible for managing aspects such as model versioning, organization, and deployment. It ensures that all models are synchronized with the ML model database 226 so that they remain up-to-date and ready for deployment.

During the deployment phase, the orchestrator service 214 is used to manage the lifecycle of the models. This service handles actions like starting, stopping, deleting, and performing health checks on the models. When a model is selected for deployment, the orchestrator service 214 pulls the model from the registry 224 and retrieves the necessary data from the ML model database 226. The orchestrator service 214 then uses this information to create deployment descriptors, typically in YAML format, which guide the deployment onto the Kubernetes (K8s) cluster. This process ensures that the model is deployed effectively and according to the predefined configurations.

In one example, the model administration interface 300 provides the actor 100 with an interactive and user-friendly UI to manage the deployment status of various machine learning models within the system. For each model listed, the UI 300 shows information such as the model's name, its current status (e.g., deployed, stopped), and buttons or options that allow the actor 100 to control the model's deployment state. The actor 100 can toggle a model between “Deploy” and “Stop” using these controls. For instance, to deploy a model that is currently inactive, the actor 100 clicks the “Deploy” button next to the model's name. Similarly, to stop a deployed model, the actor 100 clicks the “Stop” button. These actions trigger backend processes managed by the orchestrator service 214, ensuring that models are correctly started, stopped, or redeployed based on the actor's selections.

The models are deployed on the KServe platform 230, which is built on Kubernetes (one non-limiting example) and supports the deployment of various types of models, including LLMs and neural networks, all in the ONNX format. The KServe platform 230 also provides auto-scaling, logging, monitoring, and model-serving capabilities.

Once deployed, these models can be monitored using tools such as Grafana, Prometheus, and Kiali, providing real-time insights into model health, resource usage, and potential issues. A metrics and monitoring component provides real-time insights into the performance and operational status of the deployed models. This component is used to ensure the reliability, efficiency, and effectiveness of machine learning models in production environments. The metrics and monitoring interface allows the actor 100 to track various key performance indicators (KPIs) such as response times, resource utilization (e.g., CPU, GPU, memory), and model accuracy over time.

Through the interface, the actor 100 can access detailed reports and visualizations, such as graphs and dashboards, which present data on model performance and operational health. These tools enable the actor 100 to quickly identify potential issues, such as performance degradation or resource bottlenecks, and take corrective actions as necessary. For example, if a model shows declining accuracy, the actor 100 can decide to redeploy or adjust the model configuration through the orchestrator service 214.

The monitoring system is also equipped with alerting mechanisms that notify the actor 100 of critical events, such as system failures or thresholds being exceeded. These alerts can be configured to trigger automated responses or simply inform the actor 100 so that they can take manual action. By providing continuous oversight of the models'operational status, the metrics and monitoring component ensures that the models are running optimally and that any issues are promptly addressed, thereby maintaining the overall performance and stability of the system.

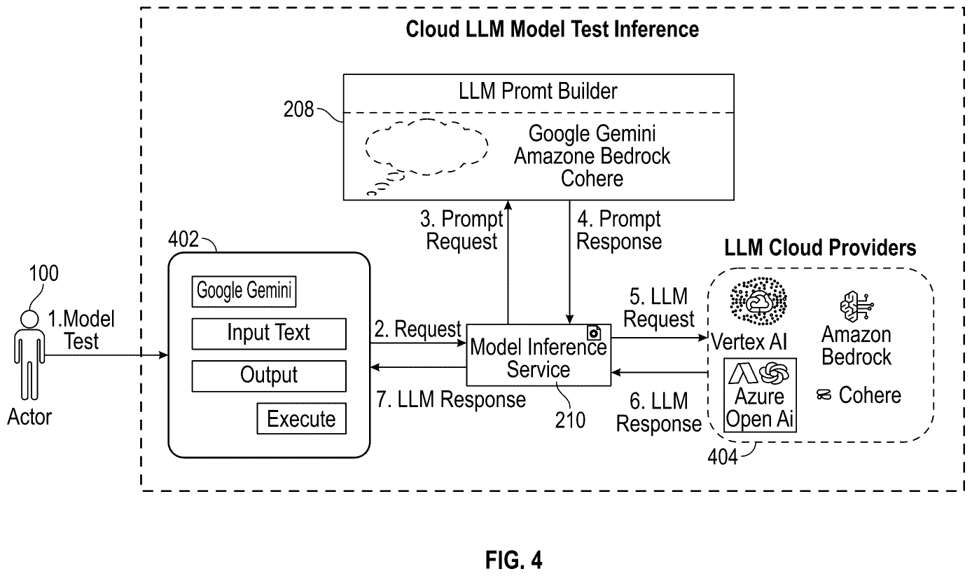

FIG. 4 illustrates the process of model test inference for cloud-based LLMs within the aviator stack. This diagram shows the interaction between the actor 100, the model test interface 402, the model inference service 210, the LLM prompt builder 208 (as seen in FIG. 2), and the LLM cloud providers 404.

The process begins when the actor 100 initiates a model test in step 1 via the model test interface 402. The actor provides input text and executes the test to evaluate how the model processes the input. Once the test is initiated, the interface sends a request in step 2 to the model inference service 210.

The model inference service 210 plays a role in processing the test request. It forwards a prompt request in step 3 to the LLM prompt builder 208. The LLM prompt builder 208 is responsible for generating a properly formatted prompt based on the input text and the specific LLM being used for inference. This prompt is then returned as a prompt response in step 4 to the model inference service 210. Next, the model inference service 210 sends an LLM request in step 5 to the appropriate LLM cloud provider, such as Google Vertex AI, Amazon Bedrock, Azure OpenAI, or Cohere. The cloud provider processes the LLM request and returns an LLM response in step 6.

Finally, the LLM response in step 6 is sent back to the model inference service 210, which then relays the LLM response in step 7 to the model test interface 402. The actor 100 can then review the output generated by the LLM to evaluate the model's performance and effectiveness in processing the input text.

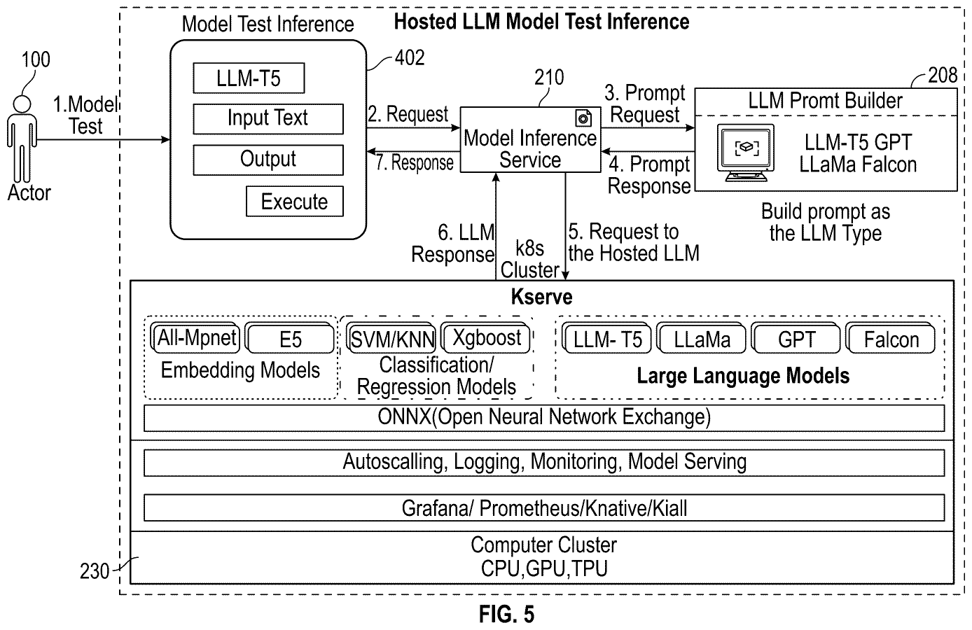

FIG. 5 illustrates the process of model test inference for hosted large language models (LLMs) within the aviator stack. This diagram demonstrates the interaction between the actor 100, the model test interface 402, the model inference service 210, the LLM prompt builder 208, and the KServe platform 230.

The process begins when the actor 100 initiates a model test in step 1 via the model test interface 402. The actor inputs text and executes the test to assess how the hosted LLM processes the provided input. Upon execution, the model test interface 402 sends a request in step 2 to the model inference service 210.

The model inference service 210 forwards a prompt request in step 3 to the LLM prompt builder 208. The LLM prompt builder 208 constructs a prompt tailored to the specific LLM type (such as LLM-T5, GPT, LLaMa, or Falcon) based on the input text. This prompt is then returned as a prompt response in step 4 to the model inference service 210.

Next, the model inference service 210 sends an LLM request in step 5 to the hosted LLM, which is deployed on the KServe platform 230 within the Kubernetes environment, as an example. The hosted LLM processes the request and generates an LLM response in step 6. Finally, the LLM response in step 6 is sent back to the model inference service 210 and then returned to the model test interface 402 as LLM response in step 7. The actor 100 can then review the output generated by the LLM to evaluate the model's performance and effectiveness.

The KServe platform 230 hosts various models, including embedding models (like all-mpnet, E5), classification/regression models (like SVM/KNN™, XGBoost™), and large language models (like LLM-T5, LLaMa, GPT, Falcon). This platform manages auto-scaling, logging, monitoring, and model serving, utilizing tools such as Grafana™, Prometheus™ Knative™, and Kiali™ to ensure efficient operation and resource allocation. In some embodiments, models are deployed on a computer cluster, which consists of CPU, GPU, and TPU resources to support the computational requirements of the hosted LLMs.

Referring back to FIG. 2, in one embodiment, the system is configured to send user queries to multiple LLMs simultaneously, leveraging the diverse capabilities of each model to generate comprehensive and accurate responses. This process begins when a query is received by the aviator query UI 200. The query is then routed through the aviator gateway 202, which plays a central role in managing the flow of information between the various components of the aviator stack.

Once the query is routed to the appropriate services by the aviator gateway 202, it is processed by the model inference service 210. The model inference service 210 is responsible for distributing the query to multiple LLMs, which may include models hosted both on-premises and in the cloud. Each LLM processes the query independently, generating its own response based on its unique training and capabilities. The responses are then sent back to the model inference service 210 for further processing.

In some instances, the orchestrator service 214 can operate in one of two modes, depending on the configuration set by the system administrators or the nature of the query. In the first mode, the orchestrator service 214 analyzes the responses from the multiple LLMs and determines the “best” answer to return to the user. This determination is made using a set of predefined criteria, which may include factors such as the relevance of the content, the confidence scores provided by each LLM, and the overall coherence and clarity of the responses. The orchestrator service 214 evaluates each response against these criteria and selects the one that best meets the requirements. This selected response is then transmitted back through the aviator gateway 202 and displayed to the user via the aviator query UI 200.

In the second mode, the orchestrator service 214 synthesizes a summary response from the various outputs generated by the LLMs. Rather than selecting a single “best” answer, the orchestrator service 214 aggregates key points, relevant information, and common insights from all the responses. This synthesis process may involve identifying overlapping themes, consolidating different perspectives, and ensuring that the final summary is both comprehensive and coherent. The summary response is then sent back to the aviator gateway 202, which routes it to the aviator query UI 200 for presentation to the user.

This dual-mode functionality of the orchestrator service 214 allows the system to adapt to different types of queries and user needs. For straightforward queries where accuracy and precision are critical, selecting the best answer from multiple LLMs ensures that the most reliable information is provided. For more complex or open-ended queries, synthesizing a summary response allows the system to present a more nuanced and detailed answer, drawing on the collective strengths of all the LLMs involved. This flexibility enhances the system's ability to deliver high-quality responses across a wide range of scenarios.

### Query Classifier

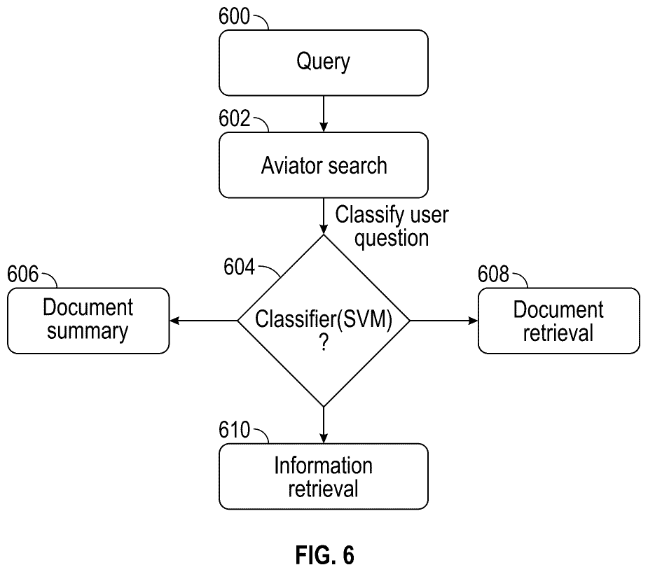

FIG. 6 illustrates the query classification process within the Aviator stack, detailing how user questions are categorized and routed to the appropriate services. The process begins with a query 600 inputted by the user into the system. This question represents the user's query or request for information, document retrieval, or a document summary.

The query 600 is first processed by the aviator search module 602 (see query UI of FIG. 1), which is responsible for receiving the user input and preparing it for further classification. The processed query is then passed to the classifier 604 (see classifier 216 of FIG. 2 as an example), which utilizes a Support Vector Machine (SVM) model to analyze the query and classify its intent. The classifier 604 determines the correct processing path for the query. Based on the analysis, the classifier 604 directs the query into one of three pathways. If the classifier 604 identifies the query as a request for a document summary, it routes the query to the document summary service 606. This service generates a concise summary of the relevant document, providing the user with a distilled version of the content. If the query is determined to be a request for document retrieval, the classifier 604 directs it to the document retrieval service 608. This service locates and retrieves the complete document that matches the user's request, ensuring that the user has access to the full content. If the classifier 604 identifies the query as a request for specific information, it is routed to the information retrieval service 610. This service extracts relevant information from various documents and presents it to the user, addressing the specific needs outlined in the query.

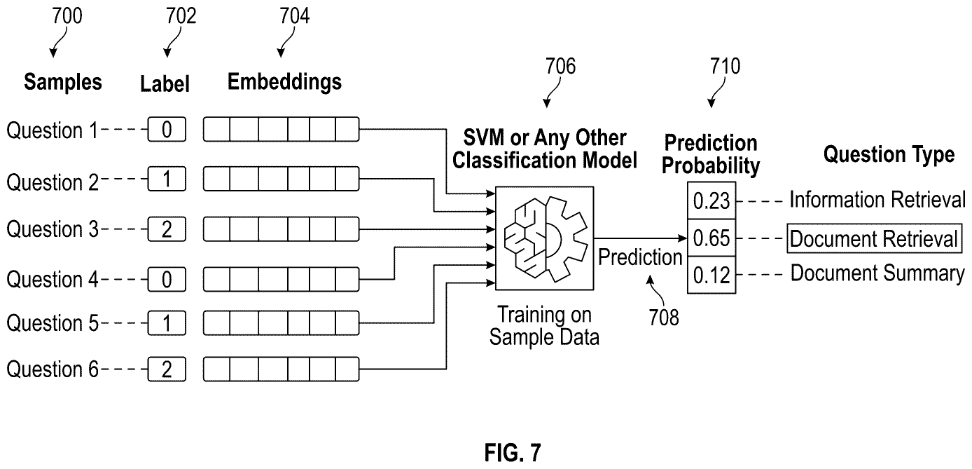

Referring now to FIG. 7, which illustrates the process of training and applying a classification model, such as a Support Vector Machine (SVM), to categorize user queries into specific types, such as information retrieval, document retrieval, or document summary.

The process begins with a set of sample queries 700. These queries represent various user queries that are to be classified. Each query in the set is assigned a label 702, which indicates the correct classification category for that query. For instance, a label of “0” might represent an information retrieval task, while a label of “1” indicates document retrieval, and “2” denotes a request for a document summary.

After labeling, each query is converted into a numerical format using embeddings 704. These embeddings are vectors that represent the semantic content of the questions, allowing the classification model to process them efficiently. Each question's embeddings are then fed into the classification model.

The classification model, which in this case could be an SVM or any other classification model 706, is trained on these sample questions and their corresponding labels. The model learns to associate certain patterns in the embeddings with specific labels, refining its ability to predict the category of new, unseen questions.

After training, the model is used to classify new questions. When a new question is input, its embeddings are processed by the trained model, which generates a prediction 708. This prediction includes a prediction probability 710, which indicates the likelihood that the question falls into each of the possible categories.

For example, in the provided figure, the model might predict that a given question has a 0.23 probability of being an information retrieval query, a 0.65 probability of being a document retrieval query, and a 0.12 probability of being a document summary request. The category with the highest probability, such as document retrieval, is selected as the predicted type for the question.

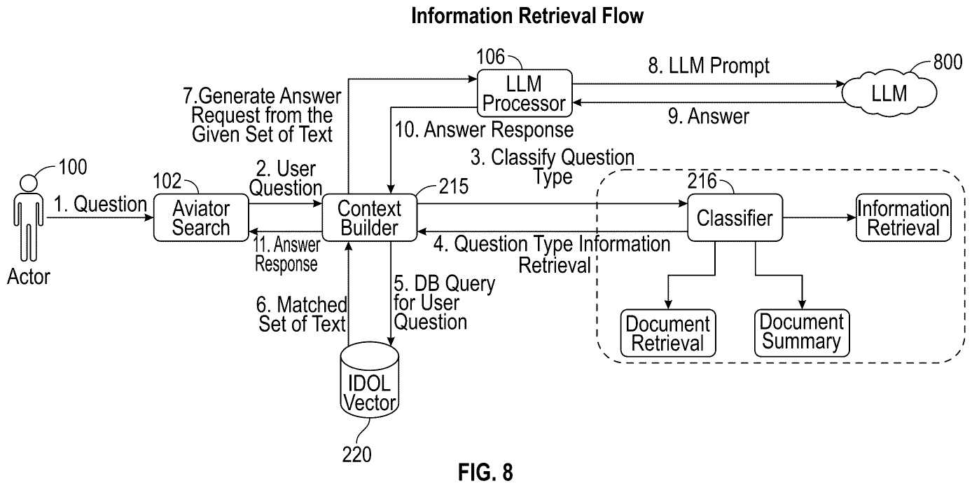

FIG. 8 illustrates the information retrieval flow within the Aviator stack, showcasing how a user's question is processed through various components to generate an appropriate response. The process begins with the actor 100 (see FIG. 1) submitting a question in step 1 to aviator search 102 (see FIG. 1). Aviator search 102 receives the user question in step 2 and initiates the search process.

The user question is then forwarded to the classifier 216 (see FIG. 2), which is responsible for determining the type of query being processed. The classifier 216 classifies the question type in step 3 and identifies whether the query pertains to information retrieval, document retrieval, or document summarization. Once the question type is identified, the classifier 216 sends the information to the context builder 215.

If the classifier 216 determines that the question is related to information retrieval, it instructs the context builder 215 to proceed with retrieving the relevant data. The context builder 215 then queries the IDOL vector database 220 database in step 5 to locate the set of text or documents that match the user question. The matched set of text 6 is returned to the context builder 215, which prepares an answer request in step 7 based on the retrieved information.

The context builder 215 passes the answer request to the LLM processor 106. The LLM processor 106 generates an LLM prompt in step 8 and sends it to the selected LLM 800 for processing. The LLM 800 processes the prompt and returns the generated answer in step 9 back to the LLM processor 106.

The LLM processor 106 then transmits the answer response in step 10 to the context builder 215, which integrates the response into a format suitable for presentation to the user. Finally, the context builder 215 sends the answer response in step 11 back to aviator search 102, which displays the response to the actor 100, completing the information retrieval flow.

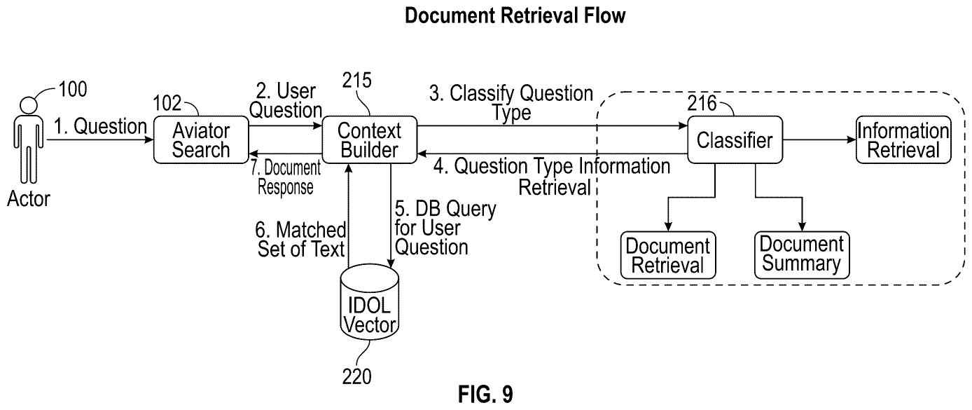

In FIG. 9, the document retrieval flow is depicted, showcasing the process by which a user, represented by an actor 100, interacts with the aviator stack to retrieve relevant documents. The flow begins with the actor 100 posing a question in step 1 to aviator search 102, initiating the process. Upon receiving the question, aviator search 102 formulates a user question in step 2 and forwards it to the context builder 215.

The context builder 215 serves to refine and contextualize the user question, ensuring that it is optimally framed for further processing. The refined question is then passed to the classifier 216, which categorizes the question into the appropriate type, such as document retrieval, information retrieval, or document summary in step 3. Based on this classification, the classifier 216 assigns the question a type of document retrieval in step 4, indicating that the question pertains to retrieving specific documents.

The context builder 214 subsequently generates a database query in step 5 corresponding to the user's question and sends it to the IDOL vector database 220. The IDOL vector database 220 processes this query and returns a matched document in step 6 that aligns with the user's query parameters. This matched document is then returned to the context builder 215, where it is assembled into a coherent document response in step 7.

Finally, the document response in step 7 is sent back to aviator search 102, where it is presented to the actor 100. This comprehensive process allows for the efficient retrieval of relevant documents in response to user queries, ensuring that the actor 100 receives accurate and contextually appropriate information.

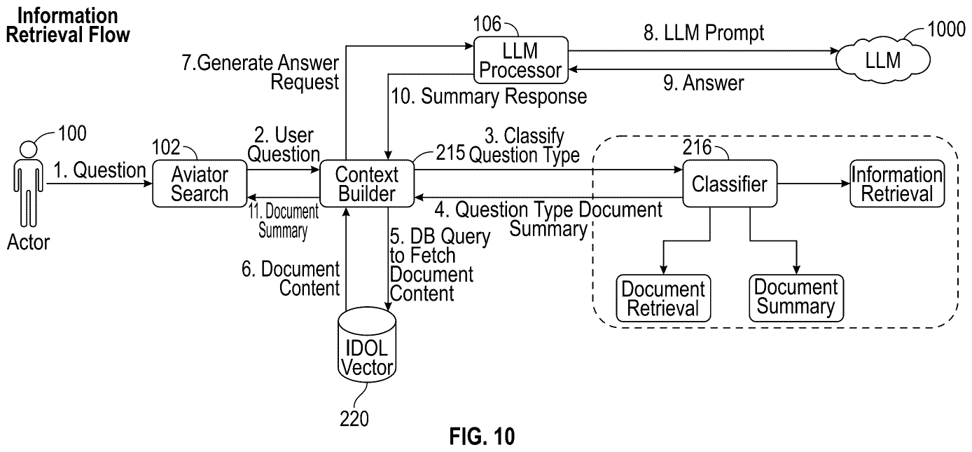

FIG. 10 illustrates the document summary flow within the aviator stack, detailing the sequential steps that take place when a user submits a query for document summarization. The process begins at step 1, where the actor 100 submits a question to the aviator search component. In step 2, the aviator search 102 component processes the user's question and forwards the user question to the context builder.

In step 3, the context builder 215 communicates with the classifier 216, which determines the type of query by classifying it. If the classifier identifies the query as a document summary type, the process continues. In step 4, based on the classification, the context builder recognizes the need to retrieve specific document content relevant to the user's question.

Next, in step 5, the context builder generates a database query to fetch the necessary document content from the IDOL vector database 220, which contains the vectorized data representations. In step 6, the IDOL vector database 220 processes the query and returns the matched document content to the context builder.

Following this, in step 7, the context builder 215 generates a summary request from the fetched document content. The summary request is then sent to the LLM processor 106 in step 8, where it is converted into an LLM prompt and transmitted to the LLM 1000 for processing.

In step 9, the LLM 1000 processes the prompt and generates a summary response, which is sent back to the LLM processor 106. This summary response is then forwarded to the context builder in step 10. Finally, in step 11, the context builder sends the summarized document content back to the aviator search component, which returns the document summary to the actor, completing the flow.

To effectively implement the query classification process described above, specific preprocessing steps, model training, and evaluation procedures are required. The following section provides detailed code snippets for preparing the dataset, generating embeddings, training the classifier model, and evaluating its performance. These snippets demonstrate how to load pre-trained models and tokenizers, process input data into a suitable format, and apply machine learning techniques to accurately classify queries based on their intent. By establishing this foundational setup, the system is equipped to categorize user queries effectively and route them through the appropriate processing flows, ensuring optimal performance and accuracy.

The provided code snippet is designed to prepare and process data for training and evaluating a machine learning classifier using the ‘transformers’ library and ‘scikit-learn’. The process begins by importing necessary libraries, including ‘AutoTokenizer’ and ‘AutoModel’ from ‘transformers’, which are used to load pre-trained models and tokenizers. Additionally, ‘LabelEncoder’ from ‘sklearn.preprocessing’ is used to encode target labels into numerical format, and ‘numpy’ is employed for handling arrays and numerical operations.

Next, the code loads a pre-trained tokenizer and a pre-trained model from specified file paths. These models, likely transformers such as BERT or GPT, have been fine-tuned or trained for specific tasks. The text data to be classified, found in the ‘question’ column of a DataFrame (‘data_df’) , is converted into a list and stored in the variable ‘X’, representing the input features. Similarly, the ‘type’ column, which contains the target labels, is converted into a list and stored in ‘y’.

The dataset is then split into training and testing sets, with 80% of the data allocated for training (‘X_train’, ‘y_train’) and 20% for testing (‘X_test’, ‘y_test’). The data is shuffled to ensure a randomized distribution, and a ‘random_state’ is set to maintain reproducibility of the results.

Following this, the training and testing data (‘X_train’ and ‘X_test’) undergo tokenization using the loaded pre-trained tokenizer. This process converts the text data into tokens that the model can process, with padding and truncation applied to standardize the input lengths. The tokens are then returned as PyTorch tensors.

Subsequently, these tokenized inputs (‘X_train_tokens’ and ‘X_test_tokens’) are passed through the pre-trained model to generate embeddings. These embeddings, which are numerical representations of the text data, capture the semantic meaning and are important for the model to perform classification. The embeddings for both the training and testing data are then converted into numpy arrays (‘X_train_vectors’ and ‘X_test_vectors’) , making them suitable for use as input features in the classifier model, such as an SVM (Support Vector Machine).

In an example process for training a classifier model, the necessary libraries and modules are first imported. These include the essential components for performing a train-test split and conducting a grid search, as well as the SVC classifier from sklearn's SVM module. Additionally, the torch library is imported to support any operations that may involve PyTorch.

The process begins by creating an SVM classifier. This classifier is configured to provide probability estimates and to use balanced class weights, which is particularly useful when dealing with imbalanced datasets.

Next, a grid of parameters is defined for the classifier. This grid includes a dictionary of possible values for the regularization parameter ‘C’ and specifies the use of the radial basis function (RBF) kernel. The grid search will explore various values for the ‘gamma’ parameter, testing both ‘auto’and ‘scale’settings to optimize model performance.

To identify the best combination of parameters, a grid search object is created. This object uses the defined parameter grid and performs grid search with 5-fold cross-validation on the training data. Cross-validation helps ensure that the model generalizes well to unseen data by testing it across different subsets of the training data.

Once the grid search is complete, the best parameters found during the process are printed. This output allows for the fine-tuning of the model to achieve the best performance. Finally, the best model identified by the grid search is retrieved and used to make predictions on the test set. This step involves applying the optimized SVM classifier to the test data, enabling the evaluation of the model's predictive accuracy on new, unseen data.

In an example process for evaluating a best model, the necessary evaluation metrics are first imported, including accuracy_score, precision_recall_curve, and auc from the sklearn.metrics module. The process begins by using the best model, previously identified through grid search, to make predictions on the test set. Specifically, the model generates predictions based on the X_test_vectors data, which represents the test set's feature vectors.

Once the predictions are made, the model's accuracy is evaluated. This is done by calculating the accuracy score, which compares the predicted labels with the true labels (y_test_encoded). The accuracy score provides a straightforward measure of the model's overall performance, indicating the proportion of correct predictions out of the total number of predictions made. Finally, the calculated accuracy is printed, allowing for a clear and immediate assessment of the model's effectiveness in predicting the correct outcomes on the test data.

The system employs a trained model to predict the type of user queries, allowing it to efficiently categorize and process questions. The following pseudo-code outlines the steps involved in taking an input question, processing it through the system's tokenizer and embedding model, and using the trained classifier to generate a prediction along with the associated probabilities. This is referred to as generating an embedding representation of the user query using a pre-trained language model.

The process begins with defining the input question, such as “What are the various services offered by Magellan?” This question serves as the basis for the subsequent steps. The system then tokenizes the input question using the embedding model's tokenizer. This tokenization step ensures that the question is appropriately formatted for the embedding model by handling padding and truncation and returning the tokenized output as tensors.

Next, the tokenized question is passed through the embedding model to generate the question embedding. The output of the model, specifically the pooler_output, is converted into a NumPy array for further processing. This embedding represents the semantic content of the question in a format that the classifier can understand.

With the question embedding ready, the system proceeds to use the trained classifier model to make predictions. The best_model.predict function generates a prediction for the question type, while best_model.predict_proba provides the probability associated with each possible class label. These predictions allow the system to determine not just the predicted label but also the confidence level of the prediction.

After obtaining the prediction, the system converts the predicted label from its numeric form to the corresponding class label using the label encoder. This conversion is essential for presenting the prediction in a human-readable format. Finally, the system prints the result, displaying the input question alongside the predicted label, the numeric prediction, and the associated prediction probabilities. This output provides a clear and concise summary of the system's classification, allowing users to understand both the predicted category and the confidence in that prediction.

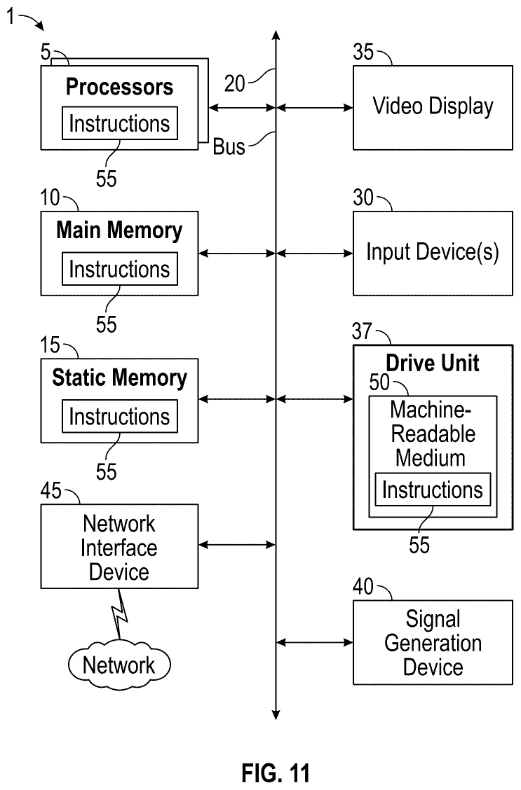

FIG. 11 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

1. A computer-implemented method for classifying a user query in a content retrieval system, the method comprising:
receiving, at a computing device, a user query;
transmitting the user query to an orchestrator service, the orchestrator service configured to manage and deploy a plurality of large language models;
generating an embedding representation of the user query using a pre-trained language model of the plurality of large language models, by utilizing embeddings which are vectors that represent semantic content of the user query;
applying a trained classifier to the embedding representation to create a classified question type for the user query, wherein the trained classifier is configured to classify the user query into one of at least three question types: an information retrieval question type, a document retrieval question type, and a document summary question type, the trained classifier having been trained on sample queries and labels based on each sample query's embeddings, the trained classifier having been further trained to associate patterns in the embeddings with specific labels, resulting in a refining of the ability of the trained classifier to classify the user query; and
generating a response to the user query based on the classified question type.

2. The method of claim 1, wherein the trained classifier is a support vector machine (SVM) classifier.

3. The method of claim 1, further comprising training the trained classifier by:
providing a plurality of labeled training queries, each labeled training query having a corresponding question type; and
training the trained classifier on the plurality of labeled training queries and a corresponding embedding representation.

4. The method of claim 1, wherein generating the response further comprises:
if the classified question type is an information retrieval question type, retrieving information related to the user query from a vector database;
synthesizing an answer to the user query based on the retrieved information; and
providing the synthesized answer to a user.

5. The method of claim 1, wherein generating the response further comprises:
if the classified question type is a document retrieval question type, retrieving a document related to the user query from a vector database; and
providing the retrieved document to a user.

6. The method of claim 1, wherein generating the response further comprises:
if the classified question type is a document summary question type, retrieving a document related to the user query from a vector database;
generating a summary of the retrieved document; and
providing the summary to a user.

7. The method of claim 1, further comprising training a support vector machine (SVM) classifier by:
receiving a plurality of labeled training queries, each labeled training query associated with a specific query type;
generating embedding representations for the labeled training queries using a pre-trained language model; and
applying the SVM classifier to the embedding representations to learn classification boundaries for distinguishing between query types.

8. The method of claim 7, wherein the specific query type includes at least an information retrieval query type, a document retrieval query type, and a document summary query type.

9. The method of claim 8, wherein the embedding representations are generated using a transformer-based language model.

10. The method of claim 9, further comprising evaluating performance of the trained SVM classifier using a test set of labeled queries and adjusting classifier parameters based on evaluation results.

11. The method of claim 10, wherein the trained SVM classifier is configured to output a probability score for each potential query type, and a query type with a highest probability score is selected as a predicted classification.

12. A computer system for classifying a user query in a content retrieval system, the computer system comprising:
a processor and memory for storing instructions, the processor executing the instructions to:
receive a user query;
transmit the user query to an orchestrator service, the orchestrator service configured to manage and deploy a plurality of large language models;
process the user query using a pre-trained language model of the plurality of large language models, by utilizing embeddings which are vectors that represent semantic content of the user query;
classify by a trained classifier the user query into one of at least three question types including an information retrieval question type, a document retrieval question type, and a document summary question type, the trained classifier having been trained on sample queries and labels based on each sample query's embeddings, the trained classifier further having been trained to associate patterns in the embeddings with specific labels, resulting in a refining of the ability of the trained classifier to classify the user query; and
generate a response to the user query based on a classified question type, wherein the response includes one of retrieving information related to the user query from a vector database and synthesizing an answer based on the retrieved information, retrieving a document related to the user query from the vector database, or generating a summary of a retrieved document from the vector database.

13. The system of claim 12, wherein the processor is configured to generate embedding representations for the user query using the pre-trained language model.

14. The system of claim 13, further comprising:
a support vector machine (SVM) classifier, wherein the processor is configured to train the SVM by:
receiving a plurality of labeled training queries, each labeled training query associated with a specific query type; and
applying the SVM classifier to the embedding representations to learn classification boundaries for distinguishing between query types.

15. The system of claim 14, wherein the query types include at least an information retrieval query type, a document retrieval query type, and a document summary query type.

16. The system of claim 15, wherein the embedding representations are generated using a transformer-based language model.

17. The system of claim 16, wherein the processor is configured to evaluate performance of the trained SVM classifier using a test set of labeled queries and adjusting classifier parameters based on the evaluation results, wherein the trained SVM classifier is configured to output a probability score for each potential query type, and the query type with a highest probability score is selected as a predicted classification.

18. A system for processing user queries in a content retrieval system, the system comprising:
a query interface configured to receive a user query and transmit the user query to a query classifier module;
a query classifier configured to apply a trained classifier to the user query to predict a query type for the user query, wherein the query type is classified into one of at least three query types: an information retrieval query type, a document retrieval query type, and a document summary query type, the trained classifier having been trained on sample queries and labels based on each sample query's embeddings, where embeddings are vectors that represent semantic content of the user query, the trained classifier further having been trained to associate patterns in the embeddings with specific labels, resulting in a refining of the ability of the trained classifier to classify the user query;
a context builder module configured to:
receive a classified query type from the query classifier module; and
generate a context for the user query based on the classified query type;
a retriever module configured to:
access and retrieve relevant information or documents from a vector database based on the context generated by the context builder module; and
a large language model (LLM) processor configured to:
receive the retrieved information or document and generate a corresponding output based on the context; and
forward output to the query interface for presentation to a user.

19. The system of claim 18, wherein the trained classifier is a support vector machine (SVM) classifier.

20. The system of claim 19, wherein the SVM classifier is trained by:
providing a plurality of labeled training queries, each labeled training query having a corresponding question type; and
training the classifier on the plurality of labeled training queries and embedding representations.
